(19) United States
(12) Patent Application Publication
(10) Pub. No.: US 2021/0226459 A1
(43) Pub. Date: Jul. 22, 2021

(54) WIRELESS CHARGER DEVICE

(71) Applicants: Ilan GERSHON, Maple (CA); Jennifer GERSHON, Maple (CA)

(72) Inventors: Ilan GERSHON, Maple (CA); Jennifer GERSHON, Maple (CA)

(21) Appl. No.: 17/148,940

(22) Filed: Jan. 14, 2021

(30) Foreign Application Priority Data
Jan. 17, 2020 (CA) 3068493

(51) Int. Cl. H02J 7/00; H02J 7/02; H01R 33/94; H01R 33/90

(52) U.S. Cl. CPC H02J 7/0044; H02J 7/02; H01R 33/90; H01R 33/94; H02J 7/0047

(57) ABSTRACT

A charger device for wirelessly charging a device. The charger device includes a plug portion and a support portion. The plug portion includes an electric plug that protrudes from the plug portion. The support portion and the plug portion are rigidly connected. At least one wireless charger circuit is disposed in the support portion, and the wireless charger circuit is electrically connected to the electric plug when the plug portion and the support portion are connected. In some example embodiments, the support portion includes an inclined surface. In some example embodiments, the support portion includes a ledge. In some embodiments, the plug portion is replaceable. In some example embodiments, the charger device includes a coupler for electrical connection to the electric plug.

### CROSS-REFERENCE

This application claims the benefit of priority to Canadian Patent Application No. 3068493 filed Jan. 17, 2020 and entitled WIRELESS CHARGER DEVICE, the contents of which are herein incorporated by reference into the DETAILED DESCRIPTION herein below.

### TECHNICAL FIELD

Example embodiments relate to charger devices, in particular to a wireless charger device that can directly plug into an electric socket without a cable.

### BACKGROUND

As battery-powered devices become more prevalent in the daily life of human beings, many different charger devices have been developed.

Some of the existing charger devices include a (long) electric cable, which is unsightly, takes up precious desktop space, and creates a tangling mess. The cable often lays on the ground or table which can be dirty, prone to damage if there is flooding, becoming wet (for example, in a kitchen), or otherwise creating an unsafe environment.

Some of the charger devices require custom installation, for example, replacing an electrical socket.

Some of the charger devices require special adapters to connect to an electric socket.

It would therefore be desirable to provide a wireless charger device that directly plugs into an existing electric socket to keep working spaces clear and fully physically supports the device being charged from contacting the ground or table.

### SUMMARY

Example embodiments relate to a wireless charger device for wirelessly charging a battery-powered electronic device. For example, the electronic device may be mobile phones, tablets, portable communication devices, watches and wireless headphones with wireless charging capabilities, e.g., Airpod™, Apple Watch™, Apple MagSafe™.

The charger device provides a support portion that supports the device being charged. In some embodiments, the support portion comprises a surface that the device being charged can lie against. In some embodiments, the support portion includes a ledge for supporting the device being charged. In some embodiments, the ledge can be horizontal or tilted to facilitate the device lying against the surface of the support portion. In some embodiments, the support portion has at least one magnet to hold the device being charged in place. The magnet may make the ledge unnecessary for supporting the device being charged.

In some embodiments, the charger device is fitted with a plug suitable for the electrical standard of the geographical region where the charger device is distributed. In some embodiments, the charger device includes a replaceable plug that can be replaced with plugs suitable for electric sockets in different regions in the world. The replaceable plug and the rest of the charger device form a rigid structure when the charger device is ready for use.

In some embodiments, the charger device includes a wireless charger circuit for wirelessly charging the electronic device, which includes a corresponding wireless receiving circuit. In some embodiments, the wireless charging is by induction. In some embodiments, the wireless charging is by magnetic resonance. In some embodiments, the wireless charger circuit and wireless receiving circuit is compliant with one or more of the Qi standard, the Power Matters Alliance (PMA) standard, the Rezence standard, or another wireless charging standard. In some embodiments, the wireless charger circuit and the wireless receiving circuit each comprises an electric circuit.

In some embodiments, the charger device includes a plug portion and a support portion. The plug portion includes an electric plug that protrudes from the plug portion. The plug portion and the support portion are rigidly connected. At least one wireless charger circuit is disposed in the support portion, and the wireless charger circuit is electrically connected to the electric plug when the support portion and the plug portion are connected.

In some embodiments, the support portion includes an inclined surface.

In some embodiments, the support portion includes a ledge that facilitates supporting the device being charged. The ledge may have a horizontal or declined upper surface. In some embodiments, the ledge is disposed at a lower portion of the support portion and extends therefrom. In some embodiments, the support portion comprises at least one magnet.

In some embodiments, a light is disposed in the support portion, and the light may be an LED light. In some embodiments, a controller is provided that controls the light to indicate the electric connection and/or charging status.

In some embodiments, the charger device includes at least one power connector port for conductive electrical connection with the electric plug. In some embodiments, the at least one power connector port includes a Universal Serial Bus (USB) port or a direct current (DC) connector port.

In some embodiments, the charger device includes a light. In some embodiments, charger device includes a switch for switching the light on or off.

In some embodiments, the plug portion is removably detachable from the support portion. In some embodiments, the charger device includes a coupler that removably and electrically connects the support portion and the plug portion.

In some embodiments, the electric plug comprises one or more prongs and the plug portion includes a surface perpendicular to an axis defined by a prong length of the one or more prongs and aligned with a proximal end of the one or more prongs.

In some embodiments, the charger device comprises a surface perpendicular to an axis defined by a prong length of the one or more prongs and aligned with a proximal end of the one or more prongs.

In some embodiments, the wireless charger circuit is compliant with one or more of Qi standard, Power Matters Alliance (PMA) standard, or Rezence standard.

In some embodiments, the support portion and the plug portion each include a respective rigid casing.

An example use of the charger device is for charging a device adapted for wireless and/or inductive charging is also provided. In some embodiments, the device is fully physically supported by the charger device when the electric plug of the charger device is plugged in.

### BRIEF DESCRIPTION OF THE DRAWINGS

Reference will now be made, by way of example, to the accompanying drawings which show example embodiments, and in which:

FIG. 1 is a perspective view of an example embodiment of the charger device.

FIG. 2 is a back view of an example embodiment of the charger device shown without a replaceable plug portion.

FIG. 3 is a rear perspective view of the charger device of FIG. 2 shown without the replaceable plug portion.

FIG. 4A is a rear perspective view of the charger device of FIG. 2 shown with the plug portion.

FIG. 4B shows some examples of different configurations of prongs of the plug portion that are suitable for different socket configurations.

FIG. 5 shows another example embodiment of the charger device, including power outlets in the form of Universal Serial Bus (USB) ports.

FIG. 6 shows another example embodiment of the charger device, including a light and a switch for the light.

FIG. 7 shows another example embodiment of the charger device, having one or more magnets for holding the device being charged in place.

FIG. 8 shows an exploded view of a system including a device to be charged, the wireless charger device, and an electrical socket.

FIG. 9A shows a rear perspective view of another example embodiment of the charger device shown with a replaceable plug portion.

FIG. 9B shows a perspective view the replaceable plug portion of FIG. 9A.

FIG. 9C shows a perspective exploded or disassembled view of the charger device of FIG. 9A.

FIG. 9D shows a rear perspective view of the charger device of FIG. 9A with a slide cover in place of the replaceable plug portion.

FIG. 9E shows a perspective view of the slide cover of FIG. 9D.

FIG. 9F shows a perspective exploded or disassembled view of the charger device of FIG. 9D.

Similar reference numerals may have been used in different figures to denote similar components.

### DETAILED DESCRIPTION

Example embodiments relate to a wireless charger device. In some examples, the wireless charger device may be suitable for other purposes, with modification as appropriate.

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

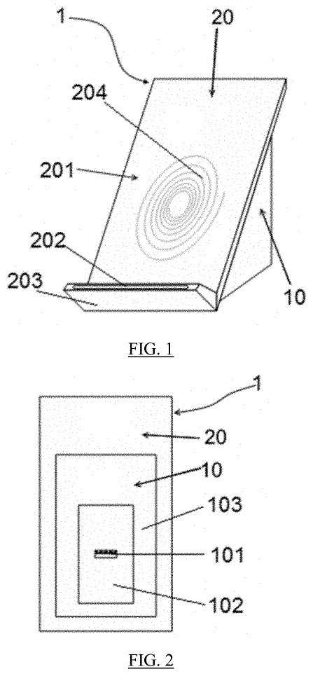

Reference is now made to FIG. 1, which shows the front perspective view of a wireless charger device 1 (referred to as “charger device”). The charger device 1 include a connector portion 10. A support portion 20 is disposed on the connector portion 10. The support portion 20 has a rigid casing. The connector portion 10 has a rigid casing. The support portion includes a surface 201 that the device being charged can lean against during charging. The charger device 1 can be plugged into an electrical socket and is configured to wirelessly charge a device having a battery. The charger device 1 fully physically supports the device being wirelessly charged from contacting the ground or table when the charger device 1 is plugged into the electrical socket. In some examples, the electrical socket can be an in-wall electrical socket. In other examples, the electrical socket can be other types of sockets such as vehicle electrical sockets.

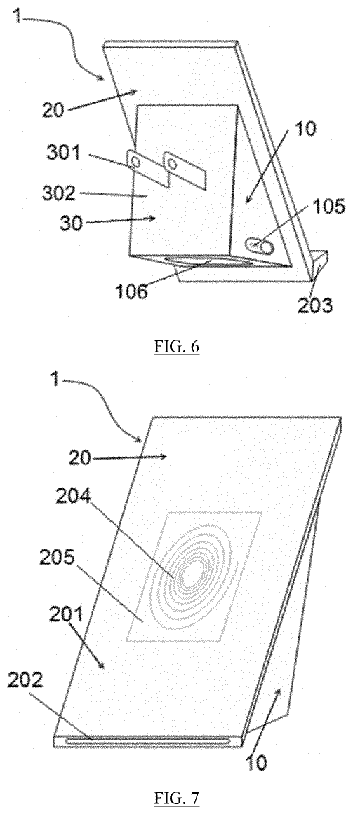

In some embodiments, the surface 201 is vertical. In some embodiments, the surface 201 is inclined. The shape of the connector portion 10 may be adjusted in response to the configuration of the surface 201. For example, when the surface 201 is inclined, the connector portion 10 may be generally shaped like a triangle, with the surface 201 disposed on one side of the triangle, as shown in FIGS. 1, 3, 4A, 4B, 5 and 6. In some embodiments, the surface 201 is horizontal.

In some embodiments, there is a ledge 203 that extends from the surface 201 for supporting the device being charged. In some embodiments, the ledge 203 has a horizontal upper surface. In some embodiments, the ledge 203 has a declined upper surface, e.g., the upper surface is angled such that the upper surface is lower where it is closer to the surface 201, such that when a device is placed on the ledge 203, the device naturally lies against the surface 201. In some embodiments, the ledge 203 is tapered, having a greater thickness closer to the surface 201. The ledge 203 is disposed on the other side of the surface 201 with respect to the connector portion 10. In some embodiments, the ledge 203 extends from a lower portion of the surface 201.

A wireless charger circuit 204 is disposed in the support portion 20 for charging a device having a battery. For example, the wireless charger circuit 204 is inside a rigid casing of the support portion 20. In some embodiments, the wireless charger circuit 204 is compliant with one or more of the wireless charging standards, for example, Qi standard, the Power Matters Alliance (PMA) standard, or the Rezence standard. In some embodiments, the wireless charging is effected by magnetic resonance. In some embodiments, the wireless charging is effected by induction. In some embodiments, the wireless charger circuit 204 is configured in a position such that the device is wirelessly charged when it is supported by the ledge 203 and leans against the surface 201. In some embodiments, the wireless charger circuit 204 may be configured in the middle of the surface 201. In some embodiments, the wireless charger circuit 204 is configured close to the ledge 203.

The size and location of the wireless charger circuit 204 may be modified to suit different devices to be charged. For example, the wireless charger circuit 204 may be of different sizes and locations with respect to the support portion for charging particular devices, such as an Apple Watch™ and an iPhone™. In some embodiments, the wireless charger circuit 204 is configured to charge different devices of different sizes or even multiple devices at the same time (may require multiple wireless charger circuits). In some embodiments, the wireless charger circuit 204 includes multiple wireless charger circuits such that multiple devices can be wirelessly charged simultaneously or that they can be charged quicker. For example, there may be at least one wireless charger circuit 204 in the surface 201 and at least one wireless charger circuit 204 in the ledge 203.

In some embodiments, a light 202 is disposed at the outer edge of the ledge 203. The light 202 may be a light emitting diode (LED) light. In some examples, the charger device 1 includes a controller or microprocessor for controlling the light 202. In some embodiments, the light 202 is controlled to change color in response to the status of the charger device 1. For example, the light 202 may be one color when the charger device 1 is plugged in an electric socket, but no device is being charged. The color of the light 202 may change when a device is being charged. The color of the light 202 may again change when the device is fully charged. In some embodiments, the light may further change to show the extent of the charge, for example 20%, 40%, 60%, etc. For example, there may be multiple lights 202, and some light 202 shines when a certain threshold of charge has been reached in the device. The color of the light 202 may also change to reflect the extent of charge. It is appreciated that the light 202 can be configured in various ways to show the status of the charger device 1 and the charging status of the device being charged.

FIGS. 2 and 3 show the back view of the charger device 1. In some embodiments, the device 1 has a coupler 101. In an example, the coupler 101 complies with USB standard. In some embodiments, the coupler 101 is a USB port or a USB plug, and the replaceable plug portion 30 includes the other of the USB port or the USB plug (not shown here). In some embodiments, the coupler 101 is disposed in a recess 102, the recess being surrounded by a surface 103. The coupler 101 is electrically connected to the wireless charger circuit 204.

In some embodiments, the support portion 20 and the connector portion 10 are constructed in a unitary structure. In some embodiments, the structural parts of the support portion 20 and the connector portion 10 may be injection molded as a single piece. In some embodiments, the structural parts of the support portion 20 and the connector portion 10 are machined from a single piece of metal.

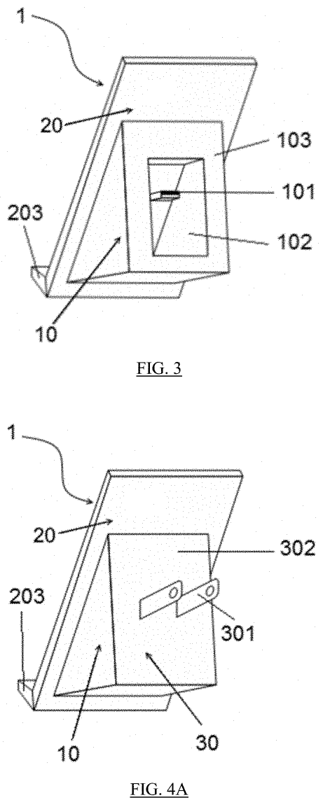

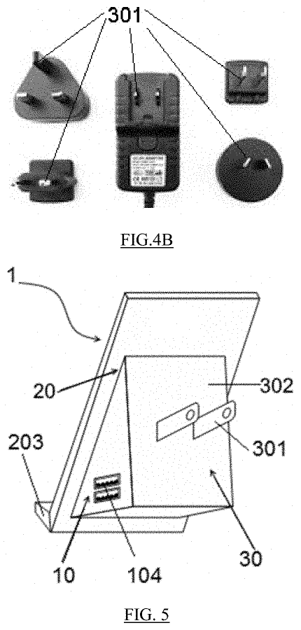

FIG. 4A shows the charger device 1 with the plug portion 30 connected to the connector portion 10. The plug portion 30 includes one or more electrical plugs (one shown) which each have a plurality of prongs 301. The prongs 301 may be configured to suit the different configurations and standards of electric sockets in different geographical regions in the world. Some of the different example configurations of the prongs 301 are shown in FIG. 4B.

In some examples, the respective rigid casings of the support portion 20, the connector portion 10 and the plug portion 30 collectively form a rigid structure. When the replaceable plug portion 30 is installed in the charger device 1, the rigid casings of the support portion 20, the connector portion 10, and the plug portion 30 collectively form a rigid structure. Therefore, in some example embodiments, the charger device 1 does not require or have any flexible cables external to the rigid casings of the support portion 20, the connector portion 10 and the plug portion 30. The charger device 1 fully physically supports the device being wirelessly charged from contacting the ground or table when the charger device 1 is plugged into the electrical socket and the device rests on the support portion 20.

In some embodiments, the plug portion 30 and the connector portion 10 are manufactured as a unitary structure. For example, the connector portion 10 and the plug portion 30 are injection-molded in a single piece. In some embodiments, the connector portion 10 and the plug portion 30 are machined form a single piece of material (e.g. metal). In some embodiments, the connector portion 10 and the plug portion 30 are welded together.

In some embodiments, the plug portion 30 is replaceable. For example, the particular prongs 301 can be selected and connected to the connector portion 10 for the electric sockets of the particular geographical region, when needed. Thus, the user need not purchase multiple devices each suitable for the sockets in a certain geographical region or a certain electrical standard implementation (e.g. in a vessel or aircraft). In this aspect, the plug portion 30 is configured with a connector corresponding to the coupler 101 such that the coupler 101 is electrically connected to the prongs 301. A mechanism may be provided to hold the connection between the plug portion 30 and the connector portion 10 in place, such as a spring member or resilient member to hold the connection together.

In some embodiments, the prongs 301 are retractable into the plug portion 30 for ease of transportation. For example, the prongs 301 can be hingedly connected to the body of the plug portion 30 using a suitable hinge.

In some embodiments, the connector of the plug portion 30 and/or the prongs 301 are rotatable in relation to the connector portion 10 to facilitate the installation of the replaceable plug portion 30 in the charger device and/or plugging the prongs 301 into the sockets. After rotation to the appropriate orientation, the plug portion 30 can be rotationally held in place using, for example, a lock, a resilient member, or using friction.

In some embodiments, the plug portion 30 includes a surface 302 that is configured to lean on the outer surface of the electric socket when the charger device 1 is plugged in. By leaning on the outer surface and/or the wall surface surrounding the electric socket, the weight from the charger device 1 and the device being charged may be supported by the outer surface and/or the wall surface. In some embodiments, the surface 302 is perpendicular to an axis defined by the prong length of the prongs 301 and aligned with a proximal end of the prongs 301. Thus, when the prongs 301 are inserted into the electric socket, the surface 302 presses against the outer surface of the electric sockets. In some embodiments, the surface 302 may be larger in area than the outer surface of the electric socket such that the surface 302 presses against the wall surface around the electric socket. In another example, not shown, the plug portion includes a plastic prong for inserting into the ground socket of an electric socket. In some examples, the surface 302 that is perpendicular to the prongs 301 for pressing against the wall surface when the prongs 301 are inserted into the electric socket can be part of the connector portion 10.

In some embodiments, the recess 102 may be configured to receive the plug portion 30 such that the surface 103 leans against the outer surface and/or the wall surface surrounding the electric socket when the charger device 1 is plugged in, such that the weight of the charger device 1 and the device being charged may be supported by the outer surface and/or the wall surface surrounding the electric socket. In some embodiments, the surface 302 also leans on the outer surface and/or the wall surface surrounding the electric socket when the charger device 1 is plugged in. For example, the surface 302 may be co-planar with the surface 103 when the plug portion 30 is received in the recess 102.

In some embodiments, the coupler 101 is a USB port such that a power adapter with a USB outlet may be used together with the charger device. The coupler 101 can plug into the USB outlet of the power adapter. In some embodiments, the recess 102 may be configured such that the power adapter is received entirely into the recess 102. In some embodiments, the surface of the power adapter where the prongs extend from may be co-planar with the surface 103. In some examples, the USB outlet provides suitable connectivity strength to hold the connection for the coupler 101.

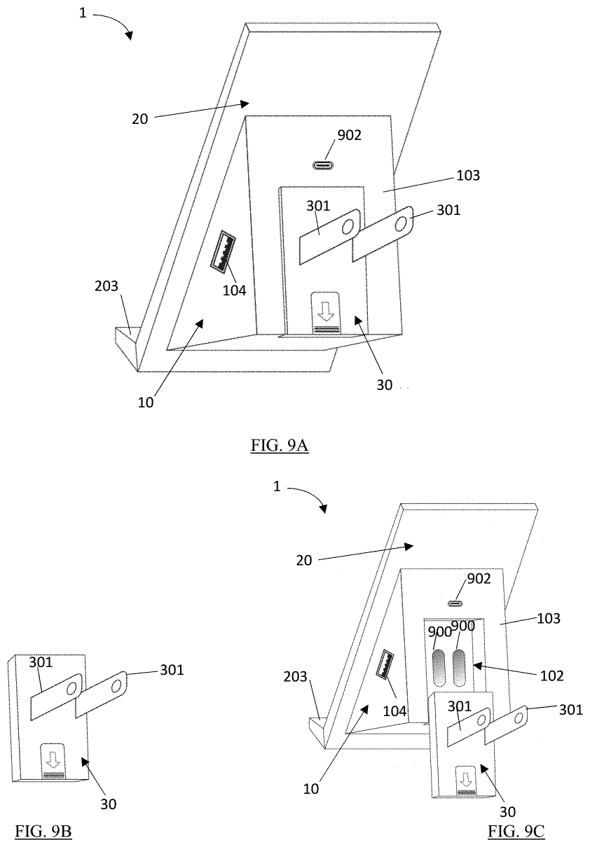

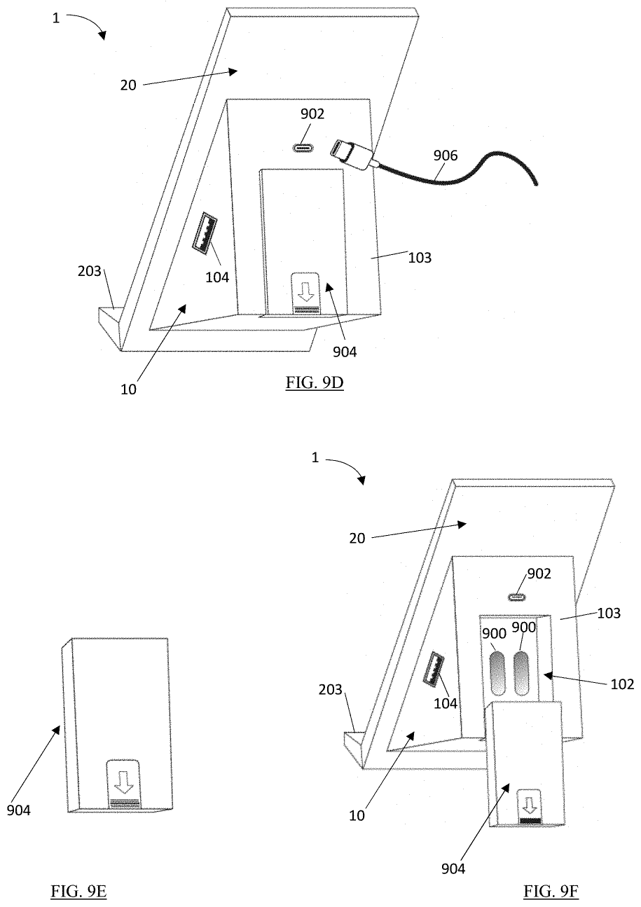

In some embodiments, additional power outlets may be configured in the charger device 1, as shown in FIG. 5. For example, the power outlets 104 may be on the connector portion 10. The power outlets 104 are in electrical connection with the prongs 301. In some embodiments, the power outlets comprise at least one USB port and/or other direct current (DC) connector port. The at least one USB port can be USB-A (as shown), or USB-C in other examples. In another example, best shown in FIG. 9A, the power outlets 104 are angled at the same angle as the surface 201, to allow optional accessories such as a USB charger for an Apple Watch to face the same angle for convenience. As described above, in various examples, the surface 201 may be vertical, inclined, or horizontal, and therefore the power outlets 104 are correspondingly angled vertically, inclined, or horizontal.

In some embodiments, the charger device 1 also includes a light 106. In some embodiments, the light 106 is disposed at the bottom of the connector portion 10, projecting the light downwardly. In some embodiments, a switch 105 is included, which switches the light 106 on and off. The switch 105 has an on position and an off position. In some embodiments, a light sensor, a motion sensor, or other sensor is included such that the light 106 may be switched on or off in response to the environmental feature detected by the sensor. In some embodiments, the light 106 functions as a night light.

In some embodiments, at least one magnet 205 is disposed in the support portion 20. The magnet 205 is configured to hold a device being charged in place. For example, the magnet 205 may be placed such that the magnetic field it generates overlaps the area covered by the wireless charger circuit 204. In some embodiments, there are multiple magnets 205 to hold the device being charged. In some embodiments, multiple wireless charger circuits 204 are provided and the magnet 205 or multiple magnets 205 hold multiple devices in place. The at least one magnet 205 is positioned to ensure proper alignment between the device and the wireless charger circuit 204, to maximize charging efficiency. An example of a module that includes the magnets and the wireless charger circuit 204 is Apple MagSafe™.

In some embodiments with the magnet 205, the ledge 203 is not needed for supporting the device, and the light 202 may be disposed in the surface 201. It is appreciated that the ledge 203 and the magnet 205 may coexist for holding the device being charged.

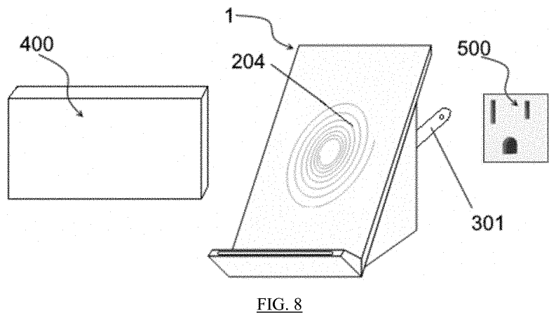

FIG. 8 illustrates a system that includes a device 400 to be charged, the wireless charger device 1, and the electrical socket 500. In some embodiments, when the device 400 needs to be charged, the wireless charger device 1 is plugged into the electrical socket 500 by the prongs 301. The device 400 is placed on the wireless charger device 1 and the wireless charger circuit 204 effects charging of the device 400. In some embodiments, the device 400 is placed on the wireless charger device 1 before the wireless charger device 1 is plugged in the electrical socket 500.

In some examples, the electrical socket 500 can be an in-wall electrical socket which is vertically oriented and installed in a vertical wall. In other examples, the electrical socket can be other types of sockets such as vehicle electrical sockets. In some examples, the electrical socket 500 is configured to suit the different configurations and standards of electric sockets in different geographical regions in the world. In some examples, the electrical socket 500 can include two electrical sockets and one ground socket, as shown. In some examples, the electrical socket 500 does not have the ground socket.

An example embodiment is the use of the charger device 1 for wirelessly charging the device 400. An example embodiment is the use of the charger device 1 for fully physically supporting the device 400 when the electric plug is plugged into an electrical socket.

FIGS. 9A, 9B, 9C, 9D, 9E, and 9F illustrate another example embodiment of the charger device 1. Similar reference numbers are used for convenience of reference. FIG. 9A shows a rear perspective view of the charger device 1, in which the front of the charger device 1 is the same or similar to the charger device 1 shown in FIG. 1. FIG. 9A shows the charger device 1 with a replaceable plug portion 30 that can be replaced with a slide cover 904 (not shown here). Accordingly, the charger device 1 is a hybrid charger device that can be plugged into the electrical socket 500 when the replaceable plug portion 30 is installed, and can be used on a flat service when the slide cover 904 is installed. FIG. 9A shows the charger device 1 shown with the replaceable plug portion 30 installed thereon. In the example of FIG. 9A, the charger device 1 is for fully physically supporting the device 400 when the replaceable plug portion 30 is plugged into an electrical socket. FIG. 9C is an exploded or disassembled view of the charger device 1 with the replaceable plug portion 30 partially removed. As shown in FIG. 9C, the connector portion 10 includes two conductive contacts 900, formed of metal, for electrically connecting to the replaceable plug portion. The two conductive contacts 900 are in the recess 102. The two conductive contacts 900 can be a hot contact and a neutral contact. In some examples, there are more than two conductive contacts 900, for example a third conductive contact as a ground contact. The replaceable plug portion 30 has two plug contacts (not shown) which electrically connects to the two conductive contacts 900 when installed. A resilient snap lock (not shown) can be used to secure the replaceable plug portion 30 to the connector portion 10.

FIG. 9B shows a detail view of the replaceable plug portion 30. The opposing side (not shown here) of the replaceable plug portion 30 includes two plug contacts (not shown) that are used to respectively contact the two conductive contacts 900 of the connector portion 10, best shown in FIG. 9C. In an example, the replaceable plug portion 30 is dimensioned for slide connection to the connector portion 10. Therefore, in an example, the replaceable plug portion 30 can be slideably connectable to the connector portion 10.

FIG. 9D shows a perspective view of the charger device 1 of FIG. 9A with the slide cover 904 which replaces the replaceable plug portion 30. The slide cover 904 is a removable cover. In an example, the slide cover 904 is dimensioned for slide connection to the connector portion 10. The slide cover 904 can be installed in place of the replaceable plug portion 30, when the replaceable plug portion 30 is removed. When the slide cover 904 is attached to the charger device 1, the charger device 1 can be used on a flat surface such as a desktop without the two conductive contacts 900 be exposed. In such an example, a DC port such as USB port 902 is used to provide power to the charger device 1, rather than through the two conductive contacts 900. As shown in FIG. 9D, a USB cord 906 is connectable to the USB port 902 to provide the power to the charger device 1. In an example, as shown, the USB port 902 is a USB-C standard port and the USB cord 906 is a USB-C standard cord. In other examples, not shown, the USB port 902 is USB-A and the USB cord 906 is a USB-A standard cord. An automatic switch circuit (not shown) can be used to select electrical connectivity from the wireless charger circuit 204 to switch between the USB port 902 and the replacement plug portion 30. FIG. 9F is an exploded or disassembled view of the charger device 1 with the slide cover 904 partially removed.

FIG. 9E shows a detail view of the slide cover 904. The slide cover 904 can be formed of insulating (non-conductive) material such as plastic. A resilient snap lock (not shown) can be used to secure the slide cover 904 to the connector portion 10.

The embodiments of the present disclosure described above are intended to be examples only. The present disclosure may be embodied in other specific forms. Alterations, modifications and variations to the disclosure may be made without departing from the intended scope of the present disclosure. While the system, devices and processes disclosed and shown herein may comprise a specific number of elements/components, the systems, devices and assemblies could be modified to include addition or fewer of such elements/components. For example, while any of the elements/components disclosed may be referenced as being singular, the embodiments disclosed herein could be modified to include a plurality of such elements/components. Selected features from one or more of the above-described embodiments may be combined to create alternative embodiments not explicitly described. All values and sub-ranges within disclosed ranges are also disclosed. The subject matter described herein intends to cover and embrace all suitable changes in technology.

What is claimed is:

1. A charger device, comprising:
a plug portion comprising an electric plug protruding from the plug portion;
a support portion rigidly connected to the plug portion; and
at least one wireless charger circuit disposed in the support portion, the at least one wireless charger circuit being in electrical connection with the electric plug when the plug portion is connected to the support portion,
wherein the plug portion is removably detachable from the support portion.

2. The charger device of claim 1, wherein the support portion comprises an inclined surface.

3. The charger device of claim 1, wherein the support portion comprises a ledge, the ledge comprising a horizontal or declined upper surface.

4. The charger device of claim 3, wherein the ledge is disposed at a lower portion of the support portion and extends therefrom.

5. The charger device of claim 1, wherein the support portion comprises at least one magnet.

6. The charger device claim 1, further comprising a light disposed in the support portion.

7. The charger device of claim 6, wherein the light is a light emitting diode (LED) light.

8. The charger device of claim 6, further comprising a controller to control the light to indicate electric connection and/or charging status.

9. The charger device of claim 1, further comprising at least one power connector port for conductive electrical connection with the electric plug.

10. The charger device of claim 9, wherein the at least one power connector port includes a Universal Serial Bus (USB) port or a direct current (DC) connector port.

11. The charger device of claim 10, wherein the support portion comprises an inclined surface, where the Universal Serial Bus (USB) port or the direct current (DC) connector port is oriented at a same angle as the inclined surface.

12. The charger device of claim 1, further comprising a second light.

13. The charger device of claim 12, further comprising a switch for switching the second light between an on and an off position.

14. The charger device of claim 1, further comprising a coupler which electrically connects the support portion and the plug portion.

15. The charger device of claim 14, wherein the coupler complies with USB standard and physically secures the support portion and the plug portion.

16. The charger device of claim 14, wherein the coupler includes at least two conductive contacts, wherein the plug portion includes at least two correspondence plug contacts for contact with the at least two conductive contacts.

17. The charger device of claim 14, further comprising a removable cover for attaching to the support portion and covering the coupler when the plug portion is detached from the support portion.

18. The charger device of claim 17, wherein the removable cover is a slide cover.

19. The charger device of claim 17, further comprising a USB port for receiving power as an alternative to the coupler and connected to the support portion away from the plug portion, further comprising a switch circuit for switching electrical connection from the at least one wireless charger circuit to between the USB port and the coupler.

20. The charger device of claim 1, further comprising a USB port connected to the support portion away from the plug portion, wherein the at least one wireless charger circuit receives power from the USB port when the plug portion is removed from the support portion, further comprising a switch circuit for switching electrical connection from the at least one wireless charger circuit to between the USB port and the plug portion.

21. The charger device of claim 1, wherein the plug portion is slideable connectable to the support portion.

22. The charger device of claim 1, wherein the electric plug comprises one or more prongs and the plug portion comprises a surface perpendicular to an axis defined by a prong length of the one or more prongs and aligned with a proximal end of the one or more prongs.

23. The charger device of claim 1, wherein the electric plug comprises one or more prongs, and the charger device further comprises a surface perpendicular to an axis defined by a prong length of the one or more prongs and aligned with a proximal end of the one or more prongs.

24. The charger device of claim 1, wherein the at least one wireless charger circuit is compliant with one or more of Qi standard, Power Matters Alliance (PMA) standard, or Rezence standard.

25. The charger device of claim 1, wherein the support portion includes a first rigid casing and the plug portion includes a second rigid casing.

26. Use of the charger device of claim 1 for charging a device adapted for wireless charging and/or inductive charging.

27. The use of claim 26, wherein the charger device fully physically supports the device when the electric plug is plugged into an electrical socket.

28. The use of claim 26, further comprising replacing the plug portion with a slide cover, wherein the charger device includes a USB port connected to the support portion away from the plug portion, wherein the at least one wireless charger circuit receives power from the USB port when the plug portion is replaced with the slide cover.
